(19) United States
(12) Patent Application Publication
(10) Pub. No.: US 2010/0121678 A1
(43) Pub. Date: May 13, 2010

(54) CALCULATING PRODUCTION CAPACITY, CAPACITY UTILIZATION, DEMAND ALLOCATION, AND AVERAGE INVENTORY LEVELS

(75) Inventor: Kevin L. McCormick, Fremont, WI (US)

Correspondence Address: Christopher M. Goff (27839);ARMSTRONG TEASDALE LLP, ONE METROPOLITAN SQUARE, SUITE 2600, ST. LOUIS, MO, 63102, US

(73) Assignee: KIMBERLY-CLARK WORLDWIDE, INC., Neenah, WI (US)

(21) Appl. No.: 12/270,312

(22) Filed: Nov. 13, 2008

(51) Int. Cl. G06Q 10/00; G06F 17/30

(52) U.S. Cl. 705/10; 705/28

(57) ABSTRACT

A processor is programmed to access the production rate of the one or more machines configured to make the one or more products stored in the memory area, access a demand rate for the one or more products stored in the memory area, calculate a production capacity of the one or more machines based on the production rate of the one or more products on the one or more machines, determine a capacity utilization based on the accessed demand rate for the one or more products and the calculated production capacity of the one or more machines, and present the determined capacity utilization to a user. An efficient demand allocation may also be determined for the machines.

### BACKGROUND

In today's competitive market, in order to be successful, companies find a right balance between having products customers want and a cost for carrying inventory. If a company does not have enough of a product (e.g., a low inventory), this may result in out-of-stock events, such as back orders, cancellations, and unsatisfied customers. However, if a company produces too much of a product (e.g., a high inventory), this may result in a waste of time, money, and space with overstocked products. Thus, companies strive to maintain sufficient production capacity (e.g. the ability to make a particular product in a set amount of time) in face of varying demand rates.

Financial decision-making processes for adding or reducing production capacity (e.g., adding or removing a machine in a production line that makes one or more products) requires an understanding of how a changed production capacity may affect a financial picture for a company. An important component of the overall financial picture is how a change in production capacity affects the manufacturer's inventory levels.

Increased production capacity allows for a decrease in inventory levels that a manufacturer maintains to avoid out-of-stock events. The increased production capacity provides a company an ability to make a product “as needed,” that is, the company does not need to carry a high level of inventory of a particular product. Due to an increased production capacity, each product can be made quickly with a shorter production cycle time, and thus a high demand may be met without overstocking a product. In contrast, if a company maintains a high level of inventory of a product, a decrease in production capacity may be needed in order to adjust to the low demand for the product.

### SUMMARY

In an embodiment, described are systems and methods for calculating production capacity and capacity utilization for a given closed-system supply/demand relationship. The method can be applied, for example, to a collection of machines at a single production facility with a collection of demand rates for products that a production facility supports. This embodiment illustrates expected tradeoffs of spending money on additional production capacity and the resulting inventory reduction that could be realized.

In another embodiment, described are systems and methods that consider and compare possible allocations on a collection of machines at a production facility. For example, if two machines can each make the same two products, demand allocation assigns a portion of each product's demand to each machine. In embodiments, the demand allocation considers all possible allocations and sieves allocations that are uniformly better than comparable allocations.

In a further embodiment, described are systems and methods for determining average inventory levels for products. The system calculates a resulting expected inventory level for each product across a collection of machines based upon production cycle lengths and inventory variation for each of the products.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is an exemplary block diagram illustrating a system for calculating capacity utilization and allocating demand among a plurality of machines.

FIG. 2 is an exemplary flow chart illustrating a method for allocating demand among a plurality of machines.

FIG. 3 is an exemplary flow chart illustrating a method for determining average inventory levels for products.

FIG. 4 is an exemplary diagram illustrating production capacity of a two-machine system where each machine makes each of two products.

FIG. 5 is an exemplary diagram illustrating production capacity on a single machine that makes two products.

Corresponding reference characters indicate corresponding parts throughout the drawings.

### DETAILED DESCRIPTION

For clarity, the disclosure is separated into three components: 1) production capacity and capacity utilization, 2) demand allocation, and 3) average inventory. The three components are separate and distinct and one component does not rely on either of the other two, in some embodiments. In other embodiments, one component relies on one or more of the other components. For example, the components tie together to give an overall system and method for quantifying a connection between production capacity and capacity utilization, demand allocation, and average inventory levels to prevent out-of-stock events. Further, although some examples provided herein assume a fixed-cycle production, one of ordinary skill in the art will appreciate that this is for explanatory purposes and does not limit the scope of the present disclosure. Rather, aspects of the invention are operable with variable-length production levels

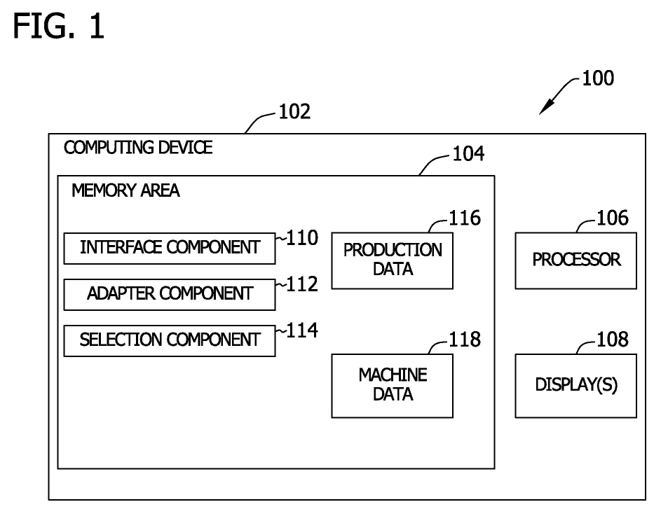

Referring to FIG. 1, an exemplary block diagram is illustrated for calculating capacity utilization among a plurality of machines in a system 100 via a computing device 102. The computing device 102 includes a memory area 104, a processor 106, and displays 108. The memory area 104 includes one or more computer-readable media. While illustrated as part of the computing device 102, the computer-readable media may be external to the computing device 102 yet connected (e.g., via a network). Further, any combination of the elements illustrated as being stored on the computer-readable media may be stored on separate media.

Memory area 104, or other computer-readable media, stores computer-executable components for calculating capacity utilization. Exemplary components include, but are not limited to, an interface component 110, an adapter component 112, and a selection component 114. The memory area further stores product data 116 and machine data 118 for storing product and machine data including, but not limited to, a production rate for one or more machines configured to make one or more products and a demand rate for the one or more products.

In embodiments, the interface component 110 receives information from a user requesting a calculation of production capacity and capacity utilization of one or more products. In embodiments, the adaptor component 112 calculates a production capacity of the one or more machines based on the production rate of the one or more products on the one or more machines. In further embodiments, the selection component determines a capacity utilization based on the demand rate for the one or more products and the calculated production capacity of the one or more machines.

One of ordinary skill in the art will appreciate that multiple machines are often able to make intersecting sets of products. As a result, production capacity is not just a number, it is a non-flat surface in a mathematical M-space (M is the number of machines). In embodiments, the collection of demand rates for a stock keeping unit (SKU) (e.g. a product) form a vector in the M-space. The practical value of production capacity is an extension of a demand vector out to a surface, and a capacity utilization is a portion of a way to this point that a demand point falls on a vector.

Production capacity and capacity utilization will now be described separately, in further detail.

### Production Capacity

To determine production capacity, the production capacity of a machine is calculated based on a production rate of a product manufactured by the machine.

For illustrative purposes, say for example, a product manufacturer makes a collection of products (e.g., packages of bath tissue). Each product has a demand rate (e.g., packages of a certain bath tissue product per week). The manufacturer has a collection of one or more machines that is responsible for meeting demand rates. Each machine is capable of making a subset of the products. In embodiments, these sets can overlap, as illustrated in Table 1 below, where X denotes that the machine is capable of making the product.

TABLE 1
Overlapping Machine Capabilities.

| | Product “A” | Product “B” | Product “C” |
|---|---|---|---|
| Machine 1 | X | X | |
| Machine 2 | | X | X |
| Machine 3 | X | X | X |

In the current example, the production/demand relationship forms a closed system (e.g. the plurality of machines do not feed demand for any other products, and the product demand is not fed by any other machines). Further, the current example applies to a single-stage production environment. For example, a process that makes bath tissue. Tissue is made into large rolls in one stage. A second stage converts the tissue into bath tissue rolls. In embodiments, the present disclosure may be used for either of these two processes, but it may not apply to both at once.

Production capacity will now be described with respect to the following formulas. However, one of ordinary skill in the art will appreciate that the following formulas are for illustrative purposes only and in no way limit the scope of the present disclosure.

Hereinafter, let “i” denote machine and “j” denote a product or stock keeping unit (SKU).

Cj=Demand rate for Product j

Pij=Production rate for Machine I making Product j

Because each product has a demand rate and each machine has a production rate for each product, the demand rate for a product is supported by a collection of the machines. This demand may be allocated across the machines in a way that each machine is responsible for a fraction of the demand. In embodiments, the fractions adds up to 1 across all the machines, for example:

$${π}_{ij} ∼ Allocation of a product j to Machine i {\sum }_{i} {π}_{ij} = 1 \\ 0 \leq {π}_{ij} \leq 1 \qquad ( 1 )$$

Thus, the fraction of a time that Machine i spends making Product j is:

$${r}_{ij} = \frac{{π}_{ij} {C}_{j}}{{P}_{ij}} ∼ Fraction of time spent producing SKU j on Machine i {\sum }_{j} {r}_{ij} \leq 1 \qquad ( 2 )$$

(the fraction rᵢⱼ does not exceed 1 when summed across the set of products)

Note that the numerator is a total demand rate for Product j that Machine i supports, and the denominator is an associated production rate. Thus, the ratio of the demand rate to the production rate dictates the percentage of a machine's time.

Thus, production capacity can be defined as:
αCⱼ where α is the largest value that satisfies:

$$α {C}_{j} = {\sum }_{i} {r}_{ij} {P}_{ij} and {\sum }_{i} {r}_{ij} = 1 \qquad ( 3 )$$

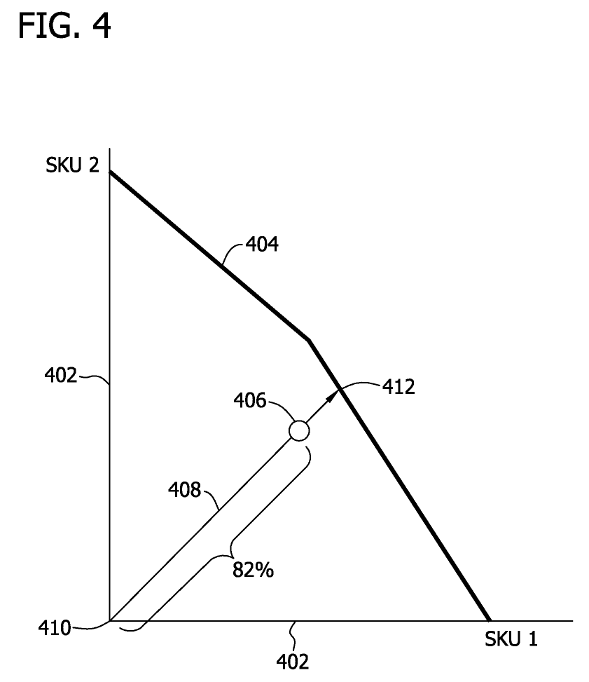

In embodiments, αCⱼ can be considered a vector in a vector space with dimensionality equal to a number of products. Graphically, this can be depicted in a special case of 2 products and 2 machines, such as shown in FIG. 4.

With continued reference to FIG. 4, axes 402 represent production rates capable of being jointly attained by, for example, two machines. Line 404 represents extremes for joint production of, for example, two products. Demand rates for the two products are depicted by point 406 on the graph represented by a circle. Thus, production capacity on this diagram is where ray 408 from origin 410 through the point 406 hits the line 412.

The example above is a practical realization of production capacity within a broader definition. That is, the broader definition of production capacity is the line 404 itself (e.g. all demand points that are (theoretically) achievable using the two machines). Practical realization is based upon a notion that if demand were to increase, it would generally tend to increase for each of the two products, thus moving outward along the ray 408.

### Capacity Utilization

In some embodiments, capacity utilization is defined as a measure of how far a demand point is along a ray, expressed as a percentage. For example, with reference to FIG. 4, if the demand point (point 406) were, for instance, on the line 412, then the demand point would be 100% of the way along the ray 408, and the capacity utilization would be 100%. As shown in the diagram in FIG. 4, the capacity utilization is roughly 80%.

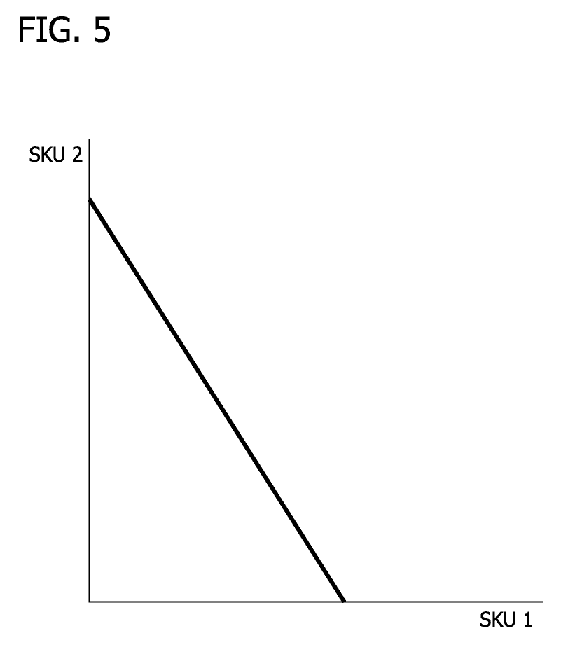

In embodiments, in a situation with multiple machines and products, the diagram shown in FIG. 4 becomes a picture in multidimensional space (e.g. one dimension for each product). Joint 414 on the line 404 arose from there being two machines in a closed system. That is, a single machine would have generated a straight heavy line as shown in FIG. 5, but in a multidimensional space, the line 404 becomes a complicated, faceted surface.

In embodiments, every point on the surface corresponds to situation where:

$$\begin{matrix}{\sum }_{j} {r}_{ij} = 1 & for all i ( machines )\end{matrix} \qquad ( 4 )$$

In further embodiments, to calculate production capacity in this general case, a linear programming application can be set up to find the largest value α so that:

$$\begin{matrix}\begin{matrix}{\sum }_{j} {r}_{ij} = 1 & for all i ( machines )\end{matrix} & ( 5 ) \\ \begin{matrix}{\sum }_{j} {π}_{ij} = 1 & for all j ( products )\end{matrix} & ( 6 ) \\ \begin{matrix}α {C}_{j} = {\sum }_{i} {r}_{ij} {P}_{ij} & for all j ( products )\end{matrix} & ( 7 )\end{matrix}$$

Equation (5) forces all machines to be fully utilized. Equation (6) indicates that 100% of a demand is allocated to a collection of machines. Equation (7) forces a solution to fall on a “heavy line” (e.g., line 404).

In embodiments, the value of “α” is greater than “i” if the demand point falls between the origin and the surface (e.g. the demand point is achievable given the machines' production speeds). Thus, capacity utilization is simply the reciprocal of α:

$$\begin{matrix}CapacityUtilization = \frac{DemandRate}{DemandRateExtrapolatedtotheBarrier} \\ = \frac{{C}_{j}}{α {C}_{j}} \\ = \frac{1}{α}\end{matrix}$$

### Demand Allocation

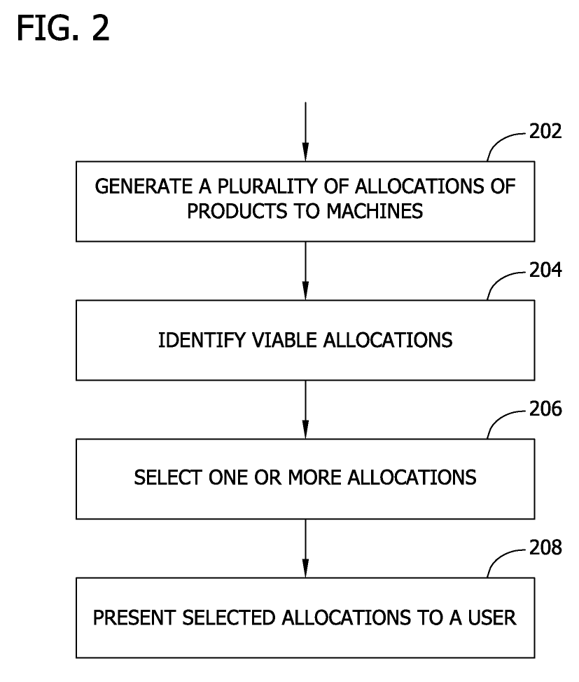

Referring now to FIG. 2, an exemplary flow chart is illustrated allocating demand among a plurality of machines. At 202, a plurality of allocations of products to machines is generated, wherein the machines are configured to produce the products according to the generated plurality of allocations. At 204, viable allocations from the generated plurality of allocations based on a set of predefined criteria are identified. At 206, one or more allocations from the identified viable allocations based on a comparison of an extra time value for each of the machines with other corresponding values in other identified viable allocations are selected. At 208, the selected allocations are presented to a user for analysis.

A demand for a set of products can generally be allocated to machines in an infinite number of ways. Thus, a demand allocation process is a systematic method for searching out all alternatives and testing them. For example, a determination is made as to whether a demand for Product “A” is assigned, for example, 30% to Machine 1 and 70% to Machine 2, 50% to Machine 1 and 50% to Machine 2, or 0% to Machine 1 and 100% to Machine 2. However, some allocations may not be viable, and of those that are viable, some may be uniformly “worse” than others and are eliminated along with the nonviable possibilities.

In embodiments, in a simple 2-machine, 2-product example where both machines are making both products (at perhaps four different production rates), one may choose to devise a production schedule where both machines make both products. One may also decide that, for example, Machine 2 will not make Product “B,” as illustrated below in Table 2:

TABLE 2
Exemplary Production Schedule.

| | Prod A | Prod B |
|---|---|---|
| Mach 1 | | |
| Mach 2 | | x |

As shown in Table 2, there are four unique ways that a single “x” can be placed in the grid. Further, there are six ways that two x's can be placed in the grid, and there are four ways that 3 x's can be placed in the grid (although three x's may result in one of the products not getting made). Thus, combinatorics may be used to generate all possible combinations of the x's. In this way, for however many machines and products there are, and acknowledging any pre-existing x's for a machine that cannot make a product, all alternatives are listed. An x in a grid is equivalent of setting a production rate for a given machine to 0 for that product.

In embodiments, a linear programming problem is set with grade change times for each machine/product combination labeled Gᵢⱼ. Grade change times are considered a time it takes to set up a production cycle for a product, regardless of which product was previously being made on a given machine. A desired production cycle length for each machine is labeled Lᵢ (below). In the below examples, it is assumed that each product is made once per production cycle. In embodiments, linear programming software varies the collection of πᵢⱼ (defined earlier) so that:

$$\begin{matrix}{\sum }_{j} {r}_{ij} \leq 1 for all I ( machines ) & ( 9 ) \\ {\sum }_{j} {π}_{ij} = 1 for all j ( products ) & ( 10 )\end{matrix}$$

With each variation, a percentage of a production cycle that is spent in production is calculated. This quantity is:

$${\sum }_{j} {r}_{ij} \qquad ( 11 )$$

In embodiments, the percentage of the production cycle that is spent doing grade changes is also calculated. This is simply a sum of grade change times (0 for any Pᵢⱼ=0).

In further embodiments, a remaining percentage of the production cycle is spent idle by the machine. The linear programming objective is to maximize the collective idle time on the machines via an objective function (for instance the sum of the squares of the idle percentages).

As mentioned above, viable allocations are identified from a generated plurality of allocations based on a set of predefined criteria. In embodiments, predefined criteria may be, for example, a solution that is not found by the linear programming software, or if any rᵢⱼ is zero for which the corresponding Pᵢⱼ is nonzero. In each case, the alternative is discarded. This is because the solution is equivalent to another alternative (e.g., the one that is identical except for an additional x in cell ij).

A result of the above process is a list of viable alternatives. A summary of viable alternatives shown in Table 3 below, lists times spent producing, grade changing, and idling for each machine.

TABLE 3
Summary of Exemplary Viable Alternatives.

| | Produce | Gr Chg | Extra |
|---|---|---|---|
| Mach 1 | 92.7% | 5.7% | 1.6% |
| Mach 2 | 89.7% | 8.6% | 1.7% |

In embodiments, the viable alternatives are then culled by discarding any viable alternative where extra time for each machine is less than a corresponding value in another viable alternative. For example, the viable alternative shown in Table 4 below may be culled on this basis when compared to the Table 3 above.

TABLE 4
Summary of Additional Exemplary Viable Alternatives.

| | Produce | Gr Chg | Extra |
|---|---|---|---|
| Mach 1 | 93.8% | 5.7% | 0.5% |
| Mach 2 | 91.4% | 8.6% | 0.0% |

In embodiments, a user may sift through a list of remaining viable alternatives and make a subjective judgment as to which alternative to employ.

### Average Inventory Levels

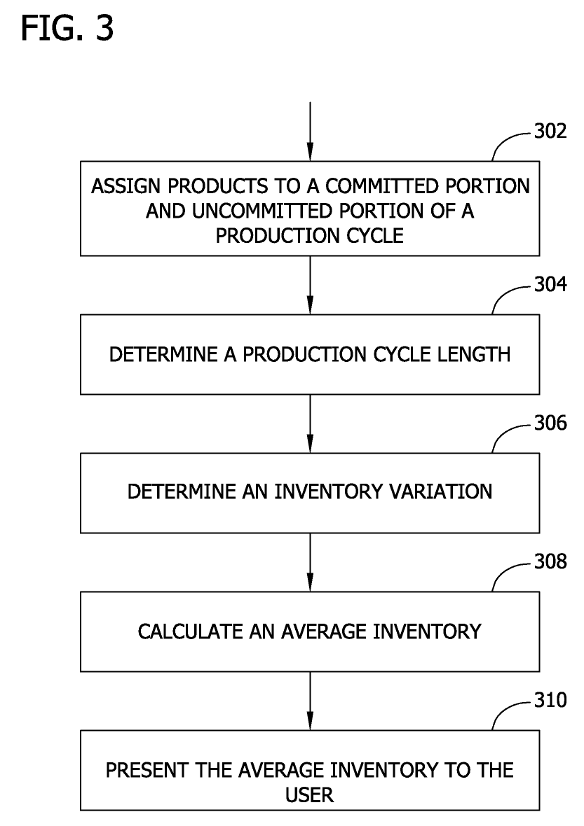

Referring now to FIG. 3, an exemplary flow chart shows a method for determining average inventory levels for products. At 302, one or more first products are assigned to a committed portion of a production cycle for a machine and one or more second products are assigned to an uncommitted portion of the production cycle for the machine. At 304, a production cycle length for the one or more first products in the committed portion of the production cycle and the one or more second products in the uncommitted portion of the production cycle is determined. At 306, an inventory variation for each of the one more first products in the committed portion and the one or more second products in the uncommitted portion is determined based on the production cycle length. At 308, an average inventory for each of the first products and the second products is calculated based on the inventory variation of the one more first products and the one or more second products. At 310, the average inventory of the first products and the second products is presented to a user.

In the embodiments described herein, it is understood that there are fixed-length production cycles on each machine, and a production cycle is constructed on a single machine that meets the machine's demand obligation of each product.

In embodiments, a determination of average inventory levels begin with demand allocation assigning a set of products that may run on a given machine along with a demand volume that machine supports. With that in place, a model may be provided for a way in which the machine executes production cycles.

In further embodiments, a demand for each product is measured by a ratio of a demand rate allocated to that machine to a production rate. For example, rᵢⱼ as described above. A product with a high rᵢⱼ value is important to a machine in a sense that the product may occupy a relatively large amount of a production cycle compared to other products that the machine makes.

For example, products may be divided into two groups, those with relatively high values for rᵢⱼ, and those with relatively low values for rᵢⱼ. The groups are called first products and second products, respectively. In embodiments, the first products occupy fixed time slots in what is termed a “committed” portion of a production cycle. The second products may be run as needed in what is termed as an “uncommitted” portion of the production cycle. In embodiments, a “cutoff value” for rᵢⱼ that separates the first products and the second products on a machine may be determined by a process that constructs production cycles. In further embodiments, the cutoff value does not have to be the same value across all machines. Table 5 is an illustrative example of a production cycle for a machine.

TABLE 5
Exemplary Production Cycle.

| | | |
|---|---|---|
| Committed | Uncommitted | Extra |

————————>
Time

In embodiments, fixed time slots are carved out for each of the first products within the committed zone. For example, as shown in Table 6 below.

TABLE 6
Exemplary Fixed Time Slot in a Production Cycle.

| | | |
|---|---|---|
| Prod. A | Prod. B | Prod. C |

In embodiments, each fixed time slot is a production run for a product. In further embodiments, each product's run begins with a downtime for grade change (length depending on the product) at the beginning of the production cycle. In some embodiments, these products have the same time slots. In still further embodiments, each of the first products occupies one (and only one) slot. However, an ordering of the products within a committed zone is important. For example, it may be desirable that a production cycle of a particular product on two machines do not happen at the same time. Therefore, if Product “A” is the first product on two machines, this would result in an unnecessarily large build of inventory for Product “A” if both machines executed a production cycle at the same time.

In embodiments, the second products may all be run in the uncommitted zone. In this embodiment, every second product may not be run in every production cycle. That is, only a small fraction of the second products may be run in any given production cycle.

Given a list of products and demand rates that a single machine supplies, an efficient (in the sense of low average inventory levels) production cycle can be constructed. The general approach is to try a cutoff value of rᵢⱼ for first products vs. second products. An exhaustive collection of production cycles is then analyzed for overall average inventory levels. In embodiments, the “best” or most efficient production cycle is picked and recorded. Then a different cutoff value is run. In embodiments, this is performed for all possible cutoff values, and the overall “best” or most efficient production cycle is selected. For example, the least dollar value for production cycle is selected as the “best” production cycle. However, other criteria for defining the “best” production cycle are within the scope of aspects of the invention.

In embodiments, the products are ordered from high to low values of rᵢⱼ. The first cutoff value is the one that admits only one product into the first product collection (the one with the highest rᵢⱼ). The second cutoff value is the one that admits only two products into the first product collection, and soon until the last cutoff is 0 (admits all products).

For a given cutoff, a collection of production cycles may be constructed, for example, as shown in table 7 below. In Table 7, two products (A and B) are first products, and three products (C, D, and E) are second products.

TABLE 7
Exemplary Collection of Production Cycles.

| | | |
|---|---|---|
| A | B | C |
| A | B | D |
| A | B | E |

For illustrative purposes, time slots for C, D, and E are considered fixed, similar to the first products. This collection of three cycles covers all of the demand for the five products. In embodiments, each cycle has a same length (L), and a run length for A is long enough so that the amount of product made during the run is enough to supply the demand for a length of time of L, and similarly for B. In embodiments, a run length for C, however, is long enough to supply demand for a time of 3 L. The production cycle length is calculated from these facts as follows:

Lr_{A}+Lr_{B}+3Lr_{C}+g_{A}+g_{B}+g_{C}+e₁=L (12)

Lr_{A}+Lr_{B}+3Lr_{D},+g_{A}+g_{B}+g_{D}+e₂=L (13)

Lr_{A}+Lr_{B}+3Lr_{E}+g_{A}+g_{B}+g_{E}+e₃=L (14)

The quantity Lr_{A} is a run length for Product “A.” This comes from the fact that r_{A} is a fraction of the machine's time that is be spent producing L. The quantity g_{A} is a grade change time for Product “A.” A quantity e₁ is extra time in a first cycle (which, visually is zero). The cycle length is the same for all three cycles. The equations are solved as follows:

E₁=L[1−(r_{A}+r_{B}+3r_{C}]−(g_{A}+g_{B}+g_{C}) (15)

E₂=L[1−(r_{A}+r_{B}+3r_{D})]−(g_{A}+g_{B}+g_{D}) (16)

E₃=L[1−(r_{A}+r_{B}+3r_{E})]−(g_{A}+g_{B}+g_{E}) (17)

The solution is the smallest value of L so that all of the eᵢ≧0. In the example, e₁ is zero. Now that L has been calculated, all of the run lengths can be found as described above.

Given the run lengths, an “inventory variation” can be found for each product as follows. For Product “A,” assume that an inventory at the start of its production cycle is I₀. Throughout the production cycle, a product is being made at a rate of PA, and it is also meeting a demand at a rate of CA. At the conclusion of the production cycle, the inventory is (assuming a steady demand rate):

I₀+(P_{A}−C_{A})Lr_{A} (18)

Here, P_{A}−C_{A} is a net inventory accumulation rate during a production cycle. The inventory variation for Product “A” is then:

Inventory Variation for Product “A”=(P_{A}−C_{A})Lr_{A} (19)

The same concept applies to Products B, C, D, and E.

Inventory Variation for Product B=(P_{B}−C_{B})Lr_{B} (20)

Inventory Variation for Product C=(P_{C}−C_{C})3Lr_{C} (21)

Inventory Variation for Product D=(P_{D},−C_{D})3Lr_{D} (22)

Inventory Variation for Product E=(P_{E}−C_{E})3Lr_{E} (23)

In embodiments, a measure of overall average inventory level for one of these five numbers can be found by taking half of variation times and carrying costs of inventory for that product. Half the variation is the average inventory as a quantity (e.g. cases of product). Application of the carrying cost turns the quantity into a dollar value. These dollar values can be summed across all five products to give a single measure that quantifies a particular collection of cycles for a particular cutoff value. The same analysis is then applied to all possible production cycle collections for the particular cutoff value. The set of all possible production cycle collections for the example above is as follows: ABC, ABD, ABE, ABCD, ABE, ABCE, ABD, ABDE, ABC, and ABCDE.

The first five are what was illustrated in Table 7. The last five are out of bounds, since this is equivalent to all five products being first products. The first four are all analyzed as described above. The one with the least dollar value is selected as the “best.” This gives a solution for the example, where the cutoff was set so that two of the five products are first products.

In embodiments, the above analysis is performed for one first product, two first products, and so on. In further embodiments, a user selects a production cycle construction to define the number of first products, the length of the committed zone, and the length of the uncommitted zone. However, the second products may not be run in a structured fashion like what was used in the above analysis. The above analysis used a structure concept illustratively to arrive at an acceptable solution to a production cycle-construction process.

With the selected cycle in hand, an amount of “extra” time may be added to the production cycle to allow for both production and demand variability. This affects an inventory variation because all of the run lengths may be longer than used in the analysis. However, this is not the end of the total average inventory picture. There are two more components. For example, when multiple machines make the same first product, inventory variation depends upon how the machine production cycles are “phased.” In embodiments, the inventory variation also sits atop a “safety stock” which also has a cost associated with it. In embodiments, safety stock is a pooled quantity for products that are made on more than one machine (e.g. the safety stock for a given product is not the sum of its safety stocks for all of the machines that make it).

The idea of safety stock is that there is a cushion to absorb demand and production variation. When inventory begins to dip into a safety stock (due to either lucky short-term high demand or unluckily low short-term production performance), some of the “extra” time built into production cycles may be used to manufacture extra product to bring the inventory up to safety stock. In embodiments, a safety stock is an amount of product that needs to be on hand that may prevent an out-of-stock condition that may occur between a time a need for extra product is identified and a time that a next production of a product commences. The standard safety stock calculation may be as follows:

Zσ\sqrt{Leadtime} (24)

The value “Z” is a statistical “Z value” corresponding to a probability on a normal probability curve. In embodiments, it is in a range of about 2 to about 3. The value a is a standard deviation of daily demand. “Leadtime” is a maximum amount of time between an end of a production cycle for a product and a start of a next production cycle. The Leadtime requires that all of the machines' production cycles to be set and phased appropriately with respect to each other.

In embodiments, for first products, the Leadtime is straightforward. For second products, the Leadtime is a multiple of a production cycle length corresponding to how many production cycles made up the analysis for the “best” (e.g., if ABDE/ABC was the best, then the multiple is 2).

In embodiments, if there is a product that is a first product on more than one machine, then it is desirable to try to avoid simultaneous production of it. The schedules for these machines may be “phased” to minimize an amount of simultaneous production. This works toward two things: 1) reducing an inventory variation for a product, and 2) shortening a safety-stock Leadtime (which may reduce the safety stock). In embodiments, phasing is possible if the production cycle lengths are either the same or share a common factor (e.g., 6 days and 8 days).

With all machine phasing complete, average inventory can be calculated. On a product by product basis, an expected inventory pattern for a first product can be calculated taking into account run lengths of a product on machines that make it within a context of phasing of the machines. Average inventory for the product is then the safety stock plus half an inventory variation. This is then converted to dollars.

In embodiments, for a second product, the phasing idea is ignored, and the variation is simply what was calculated in the earlier analysis. Half the inventory variation is then added to the safety stock to give the average inventory. This is then converted to dollars.

Thus, the overall cost of inventory is the sum of the dollar values, which plays the role of “Average Inventory” on an Inventory vs. Capacity Utilization curve.

### Exemplary Operating Environment

A computing device such as computing device 102 in FIG. 1 or a computer has one or more processors or processing units and a system memory. The computer typically has at least some form of computer readable media. Computer readable media, which include both volatile and nonvolatile media, removable and non-removable media, may be any available medium that may be accessed by computer. By way of example and not limitation, computer readable media comprise computer storage media and communication media. Computer storage media include volatile and nonvolatile, removable and non-removable media implemented in any method or technology for storage of information such as computer readable instructions, data structures, program modules or other data. For example, computer storage media include RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium that may be used to store the desired information and that may be accessed by computer. Communication media typically embody computer readable instructions, data structures, program modules, or other data in a modulated data signal such as a carrier wave or other transport mechanism and include any information delivery media. Those skilled in the art are familiar with the modulated data signal, which has one or more of its characteristics set or changed in such a manner as to encode information in the signal. Wired media, such as a wired network or direct-wired connection, and wireless media, such as acoustic, RF, infrared, and other wireless media, are examples of communication media. Combinations of any of the above are also included within the scope of computer readable media.

The system memory includes computer storage media in the form of removable and/or non-removable, volatile and/or nonvolatile memory. The computer may operate in a networked environment using logical connections to one or more remote computers, such as a remote computer.

Although described in connection with an exemplary computing system environment, embodiments of the invention are operational with numerous other general purpose or special purpose computing system environments or configurations. The computing system environment is not intended to suggest any limitation as to the scope of use or functionality of any aspect of the invention. Moreover, the computing system environment should not be interpreted as having any dependency or requirement relating to any one or combination of components illustrated in the exemplary operating environment. Examples of well known computing systems, environments, and/or configurations that may be suitable for use with aspects of the invention include, but are not limited to, personal computers, server computers, hand-held or laptop devices, multiprocessor systems, microprocessor-based systems, set top boxes, programmable consumer electronics, mobile telephones, network PCs, minicomputers, mainframe computers, distributed computing environments that include any of the above systems or devices, and the like.

Embodiments of the invention may be described in the general context of computer-executable instructions, such as program modules, executed by one or more computers or other devices. The computer-executable instructions may be organized into one or more computer-executable components or modules. Generally, program modules include, but are not limited to, routines, programs, objects, components, and data structures that perform particular tasks or implement particular abstract data types. Aspects of the invention may be implemented with any number and organization of such components or modules. For example, aspects of the invention are not limited to the specific computer-executable instructions or the specific components or modules illustrated in the figures and described herein. Other embodiments of the invention may include different computer-executable instructions or components having more or less functionality than illustrated and described herein. Aspects of the invention may also be practiced in distributed computing environments where tasks are performed by remote processing devices that are linked through a communications network. In a distributed computing environment, program modules may be located in both local and remote computer storage media including memory storage devices.

In operation, a computer executes computer-executable instructions embodied in one or more computer-executable components stored on one or more computer-readable media to implement aspects of the invention described and/or illustrated herein.

The order of execution or performance of the operations in embodiments of the invention illustrated and described herein is not essential, unless otherwise specified. That is, the operations may be performed in any order, unless otherwise specified, and embodiments of the invention may include additional or fewer operations than those disclosed herein. For example, it is contemplated that executing or performing a particular operation before, contemporaneously with, or after another operation is within the scope of aspects of the invention.

When introducing elements of aspects of the invention or the embodiments thereof, the articles “a,” “an,” “the,” and “said” are intended to mean that there are one or more of the elements. The terms “comprising,” “including,” and “having” are intended to be inclusive and mean that there may be additional elements other than the listed elements.

Having described aspects of the invention in detail, it will be apparent that modifications and variations are possible without departing from the scope of aspects of the invention as defined in the appended claims. As various changes could be made in the above constructions, products, and methods without departing from the scope of aspects of the invention, it is intended that all matter contained in the above description and shown in the accompanying drawings shall be interpreted as illustrative and not in a limiting sense.

What is claimed is:

1. A system for calculating capacity utilization, said system comprising:
a memory area for storing product and machine data including a production rate for one or more machines configured to make one or more products and a demand rate for the one or more products; and
a processor programmed to:
access the production rate of the one or more machines configured to make the one or more products stored in the memory area;
access a demand rate for the one or more products stored in the memory area;
calculate a production capacity of the one or more machines based on the production rate of the one or more products on the one or more machines;
determine a capacity utilization based on the accessed demand rate for the one or more products and the calculated production capacity of the one or more machines; and
present the determined capacity utilization to a user.

2. The system according to claim 1, wherein the system is in a single-stage production environment.

3. The system according to claim 1, wherein the demand rate is allocated across the one or more machines in a way that each machine is responsible for a fraction of the demand rate.

4. The system according to claim 3, wherein the fraction of a time that a machine spends making a product is determined by the following equation:
$${r}_{ij} = \frac{{π}_{ij} {C}_{j}}{{P}_{ij}}$$

5. A method for determining average inventory levels for products, said method comprising:
assigning one or more first products to a committed portion of a production cycle for a machine and one or more second products to an uncommitted portion of the production cycle for the machine;
determining a production cycle length for the one or more first products in the committed portion of the production cycle and the one or more second products in the uncommitted portion of the production cycle;
determining an inventory variation for each of the one more first products in the committed portion and the one or more second products in the uncommitted portion based on the production cycle length;
calculating an average inventory for each of the first products and the second products based on the inventory variation of the one more first products and the one or more second products; and
presenting the average inventory of the first products and the second products to a user.

6. The method according to claim 5, wherein the production cycle is a fixed-length production cycle.

7. The method according to claim 5, wherein the one or more first products in the committed portion are assigned to fixed time slots in the committed portion.

8. The method according to claim 7, wherein each fixed time slot is a production cycle for the one or more first products.

9. The method according to claim 5, wherein the one or more first products are a product with a high rᵢⱼ value.

10. The method according to claim 5, wherein the one or more second products are a product with a low rᵢⱼ value.

11. The method according to claim 5, wherein the one or more first products occupy more of the production cycle than the one more second products.

12. The method according to claim 5, wherein the production cycle is phased with respect to other production cycles making one or more of the same products.

13. The method according to claim 5, wherein The production cycle length is calculated from these facts as follows:
Lr_{A}+Lr_{B}+3Lr_{C}+g_{A}+g_{B}+g_{C}+e₁=L
Lr_{A}+Lr_{B}+3Lr_{D},+g_{A}+g_{B}+g_{D}+e₂=L
Lr_{A}+Lr_{B}+3Lr_{E}+g_{A}+g_{B}+g_{E}+e₃=L

14. A method for allocating demand among a plurality of machines, said method comprising:
generating a plurality of allocations of products to machines, wherein the machines are configured to produce the products according to the generated plurality of allocations;
identifying viable allocations from the generated plurality of allocations based on a set of predefined criteria;
selecting one or more allocations from the identified viable allocations based on a comparison of an extra time value for each of the machines with other corresponding values in other identified viable allocations; and
presenting the selected allocations to a user for analysis.

15. The method according to claim 14, wherein the predefined criteria is one of the following: a solution that is not found by the linear programming software, and if any rᵢⱼ is zero for which the corresponding Pᵢⱼ is nonzero.

16. The method according to claim 14, further comprising discarding any viable alternative where extra time for each of the plurality of machines is less than a corresponding value in another viable alternative.

17. The method according to claim 14, wherein each of the products is made once per production cycle.

18. A system for allocating demand among a plurality of machines, said system comprising:
a memory area for storing product and machine data including a set of predefined criteria for viable allocations of products to machines and extra time values for each of the machines; and
a processor programmed to:
generate a plurality of allocations of products to machines, wherein the machines are configured to produce the products according to the generated plurality of allocations;
identify viable allocations from the generated plurality of allocations based on a set of predefined criteria stored in the memory area;
select one or more allocations from the identified viable allocations based on a comparison of an extra time value for each of the machines stored in the memory area with other corresponding values in other identified viable allocations; and
present the selected allocations to a user for analysis.

19. The system according to claim 18, wherein the predefined criteria is one of the following: a solution that is not found by the linear programming software, and if any rᵢⱼ is zero for which the corresponding Pᵢⱼ is nonzero.

20. The system according to claim 18, wherein the processor is further configured to discard any viable alternative where extra time for each of the plurality of machines is less than a corresponding value in another viable alternative.
